(19) United States
(12) Patent Application Publication
(10) Pub. No.: US 2017/0187282 A1
(43) Pub. Date: Jun. 29, 2017

(54) CONSTANT ON-TIME SWITCHING CONVERTERS WITH ULTRASONIC MODE AND CONTROL METHODS THEREOF

(71) Applicant: Chengdu Monolithic Power Systems Co., Ltd., Chengdu (CN)

(72) Inventors: Rui Wang, Chengdu (CN); Wei Mao, Chengdu (CN)

(21) Appl. No.: 15/298,078

(22) Filed: Oct. 19, 2016

(30) Foreign Application Priority Data
Dec. 28, 2015 (CN) 201511002526.4

(51) Int. Cl. H02M 3/157; H02M 1/12

(52) U.S. Cl. CPC H02M 3/157; H02M 1/12

(57) ABSTRACT

A constant on-time switching converter includes a switching circuit, a comparing circuit, a mode determination circuit, an on-time control circuit and a logic circuit. The switching circuit has a first switch and converts an input voltage into an output voltage. The comparing circuit compares the output voltage with a reference voltage and generates a first setting signal. The mode determination circuit generates a second setting signal indicating whether the switching frequency of the switching circuit approaches an audible range. The on-time control circuit generates an on-time control signal. The logic circuit generates a control signal for controlling the first switch based on the on-time control signal, the first setting signal and the second setting signal. When the switching frequency approaches the audible range, the second setting signal transits from a first state to a second state, the first switch is turned ON.

### CROSS-REFERENCE TO RELATED APPLICATIONS

This application claims the benefit of CN application 201511002526.4, filed on Dec. 28, 2015, and incorporated herein by reference.

### TECHNICAL FIELD

The present invention generally relates to electronic circuits, and more particularly but not exclusively to constant on-time switching converters and control methods thereof.

### BACKGROUND

Constant on-time control is widely used in power supply area because of its good transient response, simple structure and smooth mode transition. In traditional switching converters with constant on-time control, a switch is turned ON when the output voltage of the switching converter is smaller than a reference voltage, and is turned OFF when its on-time reaches a predetermined time threshold. The lighter the load, the longer the switching period. So the switching frequency of the constant on-time switching converter reduces along with the load. Under light-load condition, the switching frequency of the switching converter may reduce into an audible range (such as 20 Hz˜20 kHz), so audible noise is generated.

### SUMMARY

The embodiments of the present invention are directed to a constant on-time switching converter comprising a switching circuit, a comparing circuit, a mode determination circuit, an on-time control circuit and a logic circuit. The switching circuit has a first switch and is configured to convert an input voltage into an output voltage. The comparing circuit compares a feedback signal indicative of the output voltage of the switching circuit with a reference voltage and generates a first setting signal. The mode determination circuit generates a second setting signal indicating whether the switching frequency of the switching circuit approaches an audible range. The on-time control circuit generates an on-time control signal which is used to control the on-time of the first switch. The logic circuit generates a control signal to control the first switch in the switching circuit based on the first setting signal, the second setting signal and the on-time control signal. When the switching frequency of the switching circuit approaches the audible range, the switching converter enters the ultrasonic mode, the second setting signal transits from a first state to a second state, and the first switch is turned ON.

### BRIEF DESCRIPTION OF THE DRAWING

The present invention can be further understood with reference to the following detailed description and the appended drawings.

FIG. 1 illustrates a block diagram of a constant on-time switching converter 100 in accordance with an embodiment of the present invention.

FIG. 2 illustrate working waveforms of a prior art constant on-time switching converter and the switching converter 100 in accordance with embodiments of the present invention during light-load condition.

FIG. 3 illustrates a schematic circuitry diagram of a constant on-time switching converter 200 in accordance with an embodiment of the present invention.

FIG. 4 illustrate working waveforms of the switching converter 200 shown in FIG. 3 and the switching converter 100 shown in FIG. 1 in ultrasonic mode.

FIG. 5 illustrates a schematic circuitry diagram of a constant on-time switching converter 300 in accordance with another embodiment of the present invention.

FIG. 6 illustrates a schematic circuitry diagram of a discharge circuit 207A in accordance with an embodiment of the present invention.

FIG. 7 illustrates a schematic circuitry diagram of a discharge circuit 207B in accordance with another embodiment of the present invention.

FIG. 8 illustrates a schematic circuitry diagram of a constant on-time switching converter 400 in accordance with yet another embodiment of the present invention.

FIG. 9 illustrates a flow chart of a method 500 for controlling a switching converter in accordance with an embodiment of the present invention.

The use of the same reference label in different drawings indicates the same or like components.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

According to embodiments of the present invention, in normal working state, a switch in a constant on-time switching converter is turned ON when an output voltage of the switching converter is smaller than a reference voltage, and is turned OFF when its on-time reaches a predetermined time threshold. Once the switching frequency of the switching converter approaches an audible range (such as 20 Hz-20 kHz) during light-load or no-load conditions, the switching converter enters into an ultrasonic mode, the switch is forcibly turned ON even if the output voltage is still higher than the reference voltage. The ultrasonic mode keeps the switching frequency above the audible frequency area and thus audible noise is avoided.

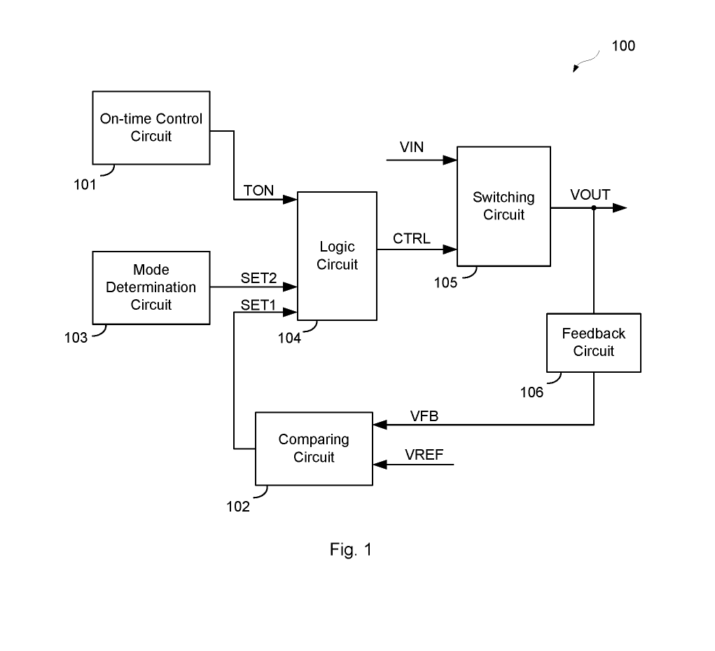

FIG. 1 illustrates a block diagram of a constant on-time switching converter 100 in accordance with an embodiment of the present invention. The switching converter 100 comprises an on-time control circuit 101, a comparing circuit 102, a mode determined circuit 103, a logic circuit 104, a switching circuit 105 and a feedback circuit 106. The on-time control circuit 101, the comparing circuit 102, the mode determination circuit 103 and the logic circuit 104 may be fabricated in an integrated circuit, such as an analog IC, digital IC or analog-digital IC. The switching circuit 105 comprises a first switch and is configured to convert an input voltage VIN into an output voltage VOUT via turning ON and OFF of the first switch. The switching circuit 105 may be configured in any DC/DC or AC/DC topologies, such as synchronous or asynchronous Buck, Boost, Forward and Flyback converters. The switch in the switching circuit 105 may be any controllable semiconductor device, such as MOSFET, IGBT, and so on. The feedback circuit 106 is coupled to an output terminal of the switching circuit 105 to receive the output voltage VOUT, and is configured to generate a feedback signal VFB indicative of the output voltage VOUT. Persons of ordinary skill in the art can recognize, however, that the feedback circuit 106 is not necessary and can be omitted.

The on-time control circuit 101 generates an on-time control signal TON to control the on-time of the first switch in the switching circuit 105. The comparing circuit 102 is coupled to the feedback circuit 106, and is configured to compare the feedback signal VFB with a reference voltage VREF and to generate a first setting signal SET1. The mode determination circuit 103 is configured to judge whether the switching frequency FS of the switching converter 100 approaches the audible range and to generate a second setting signal SET2. The second setting signal SET2 transits from a first state to a second state when the switching frequency FS approaches the audible range. The logic circuit 104 is coupled to the on-time control circuit 101, the comparing circuit 102 and the mode determination circuit 103. The logic circuit 104 generates a control signal CTRL based on the on-time control signal TON, the first setting signal SET1 and the second setting signal SET2, so as to control the first switch in the switching circuit 105. Generally, in normal working state, the first switch is turned ON when the feedback signal VFB is smaller than the reference voltage VREF, and is turned OFF when its on-time reaches a time threshold determined by the on-time control signal TON. However, when the switching frequency Fs of the switching circuit 105 approaches the audible range, the switching converter 100 enters the ultrasonic mode, the second setting signal SET2 transits from the first state to the second state, the first switch is turned ON and the switching frequency FS is limited to a minimum larger than 20 kHz. The minimum is above the audible frequency area, so audible noise is avoided.

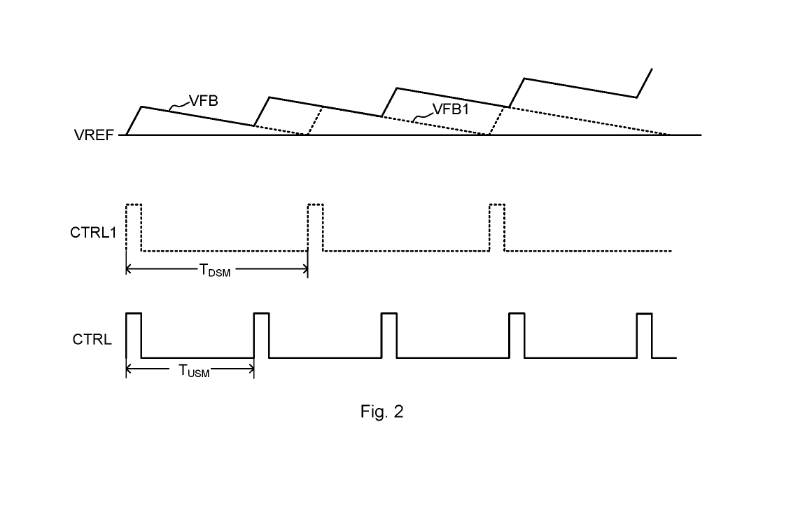

FIG. 2 illustrate working waveforms of a prior art constant on-time switching converter and the switching converter 100 in accordance with embodiments of the present invention during light-load condition. VFB1 and CTRL1 respectively represent the feedback signal and control signal in the prior art switching converter. VFB and CTRL respectively represent the feedback signal and control signal in the switching converter 100 shown in FIG. 1. For the prior art switching converter, the first switch is turned ON only when the feedback signal VFB1 decreases to the reference voltage VREF, and wherein T_{DSM} represents the switching period of the prior art switching converter under light-load condition. However, for the switching converter 100 of the present invention, if the switching period of the switching converter 100 exceeds an ultrasonic time threshold T_{USM} (such as 50 μs), the switching frequency FS will be deemed as approaching the audible range, the switching converter 100 will enter into the ultrasonic mode, the second setting signal SET2 is at the second state, the first switch is turned ON even if the feedback signal VFB is still higher than the reference voltage VREF. The switching frequency FS is constrained to be the minimum larger than 20 kHz, so audible noise is avoided. Moreover, when the load of the switching circuit 105 increases and the switching frequency FS is far away from the audible range, the switching converter 100 will exit the ultrasonic mode and resume to normal operation.

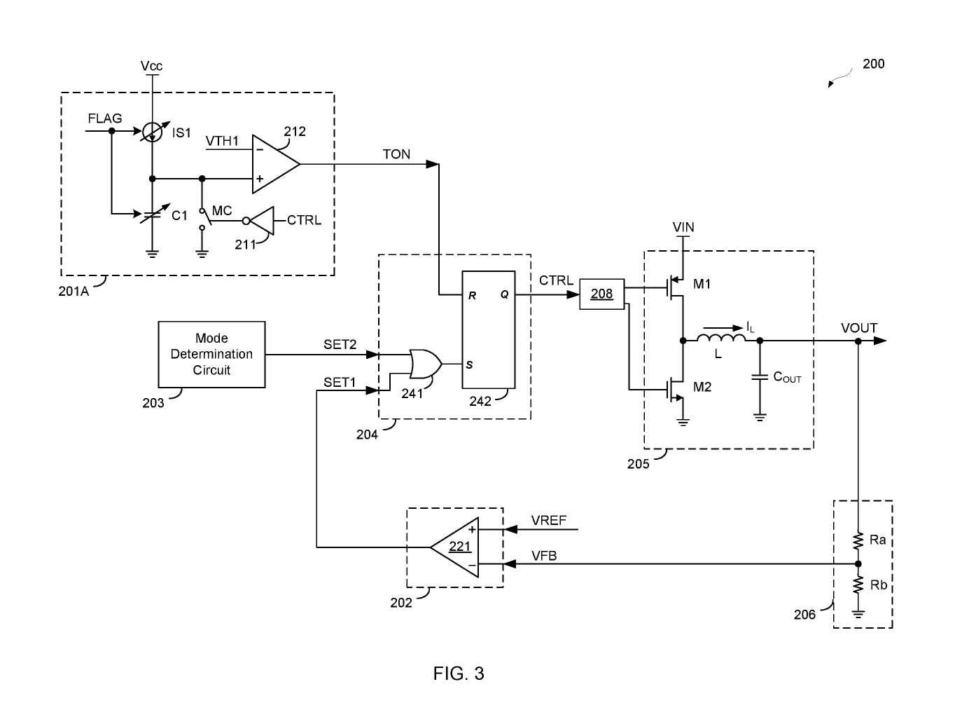

In the constant on-time control method, when the feedback signal VFB falls below the reference voltage VREF, the first switch is turned ON and the switching converter delivers energy to the load whereby the amount of energy delivered by the converter is determined by the on-time control signal TON. However, according to embodiments of the present invention, since the switching frequency FS in ultrasonic mode is limited at a minimum above the audible range during light-load or no-load conditions, the on-time control signal TON could not meet the energy requirement, encountering the output voltage overshoot issue. For this reason, all the embodiments (FIGS. 3˜8) described below is configured to avoid the audible noise and further still solve the output voltage overshoot issue in the switching converter 100 with the limited switching frequency FS.

FIG. 3 illustrates a schematic circuitry diagram of a constant on-time switching converter 200 in accordance with an embodiment of the present invention. The switching converter 200 comprises a control circuit, a switching circuit 205 and a feedback circuit 206. The control circuit comprises an on-time control circuit 201A, a comparing circuit 202, a mode determination circuit 203 and a logic circuit 204. The switching circuit 205 is configured in a Buck converter. It comprises a first switch M1, a second switch M2, an inductor L and an output capacitor COUT. The feedback circuit 206 comprises a resistor divider which consists of resistors Ra and Rb. The resistor divider is coupled to an output terminal of the switching circuit 205 and is configured to generate a feedback signal VFB indicative of the output voltage VOUT.

The on-time control circuit 201A is configured to generate an on-time control signal TON which is used to control the on-time of the first switch M1. The comparing circuit 202 comprises a comparator 221 having a non-inverting input terminal, an inverting input terminal and an output terminal, wherein the non-inverting input terminal is configured to receive a reference voltage VREF, the inverting input terminal is coupled to the feedback circuit 206 to receive the feedback signal VFB, the comparator 221 provides a first setting signal SET1 at the output terminal by comparing the feedback signal VFB with the reference voltage VREF. The mode determination circuit 203 is configured to judge whether the switching frequency FS of the switching converter 200 approaches an audible range and generates a second setting signal SET2. The second setting signal SET2 transits from a first state to a second state when the switching frequency FS approaches the audible range. There are many ways that can be used to judge whether the switching frequency FS of the switching converter approaches the audible range. In an embodiment, the switching frequency FS may be compared with a predetermined frequency Fth. If the current switching frequency is less than the predetermined frequency Fth (such as 25 KHz), or the current switching frequency is continuously less than the predetermined frequency Fth in a predetermined time period, the switching converter 200 will be deemed as approaching the audible range. In another embodiment, if the time period when both switches M1 and M2 in the switching circuit are turned OFF exceeds a first time threshold TTH1 (such as 30 μs), the switching converter 200 will be deemed as approaching the audible range. In other embodiments, the judging of approaching the audible range may be realized by other suitable methods/means.

The logic circuit 204 comprises an OR gate 241 and a flip-flop 242. The OR gate 241 has a first input terminal, a second input terminal and an output terminal, wherein the first input terminal is coupled to the output terminal of the comparing circuit 202 to receive the first setting signal SET1, the second input terminal is coupled to the mode determination circuit 203 to receive the second setting signal SET2. The flip-flop 242 has a setting terminal, a resetting terminal and an output terminal, wherein the setting terminal is coupled to the output terminal of the OR gate 241, the resetting terminal is coupled to coupled to the on-time control circuit 201A to receive the on-time control signal TON, the flip-flop 242 provides the control signal CTRL at the output terminal. Accordingly, the first switch M1 is turned ON when the feedback signal VFB is smaller than the reference voltage VREF or the second setting signal SET2 transits from the first state to the second state, and the first switch M1 is turned OFF when its on-time reaches a time threshold determined by the on-time control signal TON. A person of ordinary skill in the art should know that in other embodiments, the logic circuit 204 may have different circuit configurations while having the same or similar function.

In the ultrasonic mode, the on-time control signal TON is regulated to reduce the on-time of the first switch M1 when an over-voltage condition of the output voltage VOUT over a first output limit is detected, and thus the energy delivered to the load is reduced, the output voltage VOUT can be reduced. In the embodiment of FIG. 3, the on-time control circuit 201A comprises a current source 1S1, a capacitor C1, a control switch MC, a comparator 212 and a NOT gate 211. The current source IS1 has a first terminal and a second terminal, wherein the first terminal is coupled to a power supply Vcc, the second terminal is configured to provide a charge current to charge the capacitor C1. The capacitor C1 has a first terminal and a second terminal, wherein the first terminal is coupled to the second terminal of the current source 1S1, the second terminal is grounded. The control switch MC has a first terminal, a second terminal and a control terminal, wherein the first terminal is coupled to the second terminal of the current source IS1, the second terminal is grounded. The NOT gate 211 has an input terminal and an output terminal, wherein the input terminal is coupled to the output terminal of the logic circuit 204 to receive the control signal CTRL, the output terminal is coupled to the control terminal of the control switch MC. The comparator 212 has a non-inverting input terminal, an inverting input terminal and an output terminal, wherein the non-inverting input terminal is coupled to the first terminal of the control switch MC and the first terminal of the capacitor C1, the inverting input terminal is configured to receive a threshold voltage VTH1, and the output terminal is configured to provide the on-time control signal TON.

In one embodiment, the threshold voltage VTH1 is the output voltage VOUT. In another embodiment, the charge current outputted by the current source IS1 is determined by a status signal FLAG, wherein when the output voltage VOUT is less than the first output limit, the status signal FLAG is at the normal logic state, the charge current may be a predetermined constant value, or a variable value determined by the input voltage VIN, for example, the charge current increases when the input voltage VIN increases. When the output voltage VOUT is higher than the first output limit, the status signal FLAG is at the over-voltage logic state, the on-time control circuit 201A increases the charge current to reduce the on-time of the first switch M1. In another embodiment, the capacitance of the capacitor C1 is determined by the status signal FLAG, wherein when the output voltage VOUT is higher than the first output limit, the status signal FLAG transits from the normal logic state to the over-voltage logic state, the on-time control signal TON is regulated by reducing the capacitance of the capacitor C1 to reduce the on-time of the first switch M1.

In one embodiment, the switching converter 200 further comprises a driver circuit 208. The driver circuit 208 has an input terminal and output terminals, wherein the input terminal is coupled to the output terminal of the logic circuit 204, the output terminals are respectively coupled to the first switch M1 and the second switch M2 in the switching circuit 205. In one embodiment, in order to eliminate the sub-harmonic oscillation at the output voltage VOUT, the switching converter 200 further comprises a slope compensation circuit providing a slope compensation signal. The slope compensation signal may be added to the feedback signal VFB, or be subtracted from the reference voltage VREF.

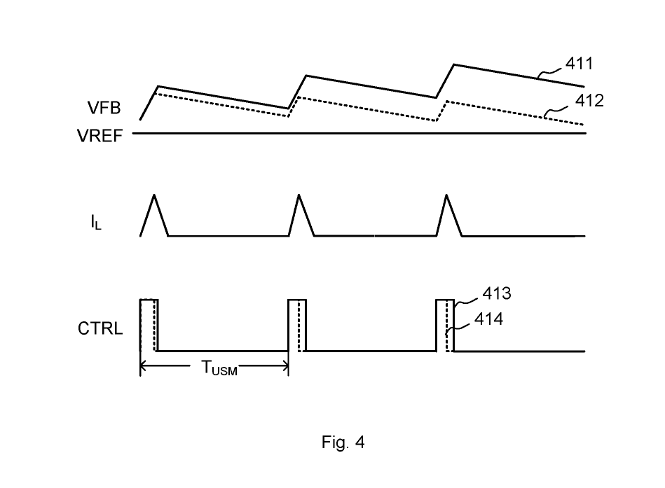

FIG. 4 illustrate working waveforms of the switching converter 200 shown in FIG. 3 and the switching converter 100 shown in FIG. 1 in ultrasonic mode. As shown in FIG. 4, the label 411 and 412 respectively represent the feedback signal VFB of the switching converter 100 of FIG. 1 and switching converter 200 of FIG. 3. The label 413 and 414 respectively represent the control signal CTRL of the switching converter 100 and switching converter 200. The label I_{L} represents the current flowing though the inductor L in the switching circuit 205. It can be seen from FIG. 4, the output overshoot issue can be solved by reducing the on-time of the first switch M1 in ultrasonic mode. Moreover, the reduction of the on-time can reduce the conduction loss of the switch and hence the efficiency of the switching converter 200 is improved.

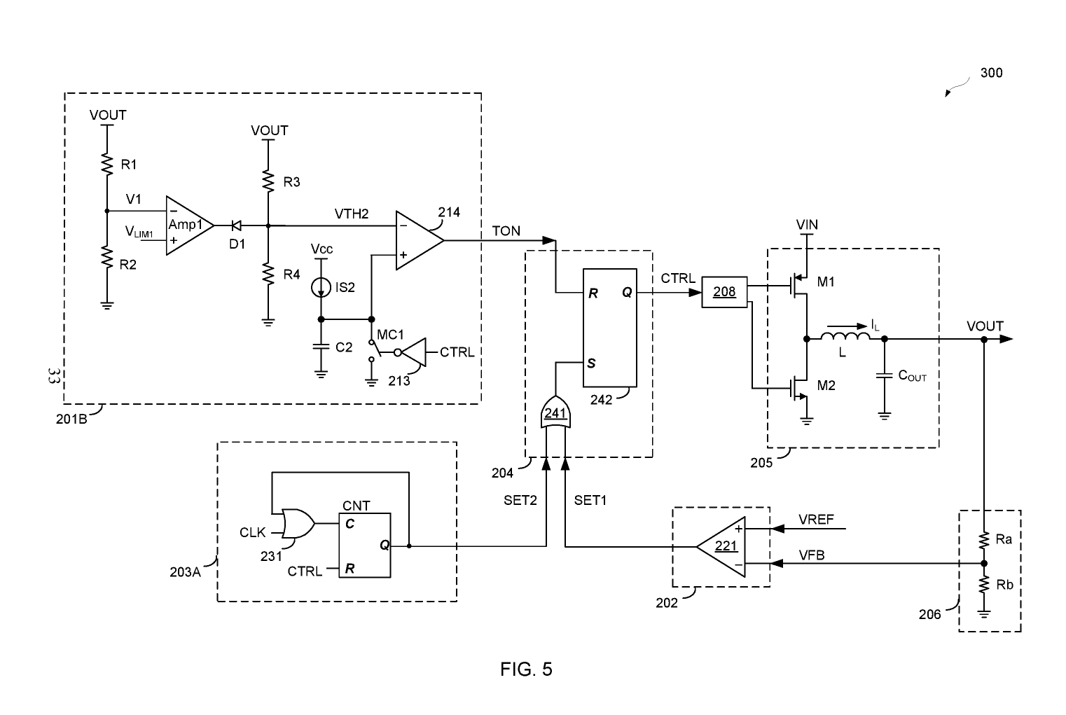

FIG. 5 illustrates a schematic circuitry diagram of a constant on-time switching converter 300 in accordance with another embodiment of the present invention. The switching converter 300 comprises a control circuit, the switching circuit 205 and the feedback circuit 206. The control circuit comprises an on-time control circuit 201B, the comparing circuit 202, a mode determination circuit 203A and the logic circuit 204.

The mode determination circuit 203A is configured to monitor the off-time of the first switch M1 and to generate a second setting signal SET2 indicating whether the switching frequency FS of the switching converter 300 approaches the audible range. In detail, the second setting signal SET2 is at the first state when the off-time of the first switch M1 is less than a second time threshold TTH2, such as 33 μs. When the off-time of the first switch M1 exceeds the second time threshold TTH2, the second setting signal SET2 is at the second state, the switching converter 300 enters the ultrasonic mode, and the first switch M1 is turned ON. The mode determination circuit 203A comprises an OR gate 231 and a timer CNT. The OR gate 231 has a first input terminal, a second input terminal and an output terminal, wherein the first terminal is coupled to receive a clock signal CLK, a second input terminal is coupled to receive the second setting signal SET2. The timer CNT has a clock terminal, an input terminal and an output terminal, wherein the clock terminal is coupled to the output terminal of the OR gate 231, the input terminal is coupled to receive the control signal CTRL. The timer CNT starts counting when the control signal CTRL transits from logic high state to logic low state. The timer CNT has a reference time which equals with the second time threshold TTH2. If the counting duration of the timer CNT exceeds the reference time, then at the end of the reference time, if the control signal CTRL is still at logic low state, and the second setting signal SET2 provided by the timer CNT transits from logic low state to logic high state, the first switch M1 in the switching circuit 205 is turned ON. The timer CNT stops counting when the control signal CTRL transits from logic low state to logic high state and is cleared.

The on-time control circuit 210B is configured to generate the on-time control signal TON. In ultrasonic mode, the on-time control signal TON is regulated to reduce the on-time of the first switch M1 based on the over-voltage condition of the output voltage VOUT over a first output limit, and hence the output voltage VOUT is reduced. The on-time control circuit 210B comprises resistors R1-R4, a current operational amplifier Amp1, a diode D1, a current source IS2, a capacitor C2, a Not gate 213, a control switch MC1 and a comparator 214. As shown in FIG. 5, the resistor R1 has a first terminal and a second terminal, wherein the first terminal is coupled to receive the output voltage VOUT. The resistor R2 has a first terminal and a second terminal, wherein the first terminal is coupled to the second terminal of the resistor R1, the second terminal is grounded. The common node of resistors R1 and R2 is configured to provide a first voltage V1 related to the output voltage VOUT. The current operational amplifier Amp1 has a non-inverting input terminal, an inverting input terminal and an output terminal, wherein the non-inverting input terminal is configured to receive the first voltage limit V_{LIM1}, the inverting input terminal is coupled to the second terminal of the resistor R1 to receive the first voltage V1, and the output terminal is configured to provide a first current. The diode D1 has an anode and a cathode, wherein the cathode is coupled to the output terminal of the current operational amplifier Amp1. The resistor R3 has a first terminal and a second terminal, wherein the first terminal is coupled to receive the output voltage VOUT, the second terminal is coupled to the anode of the diode D1. The resistor R4 has a first terminal and a second terminal, wherein the first terminal is coupled to the second terminal of the resistor R3 and the anode of the diode D1, the second terminal is grounded. The common node of resistors R3 and R4 is configured to provide a threshold voltage VTH2. The current source IS2 has a first terminal and a second terminal, wherein the first terminal is coupled to a power supply Vcc, the second terminal is configured to provide a charge current. In one embodiment, the charge current is proportional to the input voltage VIN. The capacitor C2 has a first terminal and a second terminal, wherein the first terminal is coupled to the second terminal of the current source IS2, the second terminal is grounded. The control switch MC1 has a first terminal, a second terminal and a control terminal, wherein the first terminal is coupled to the first terminal of the capacitor C2, the second terminal is grounded. The NOT gate 213 has an input terminal coupled to receive the control signal CTRL and an output terminal coupled to the control terminal of the control switch MC1. The comparator 214 has a non-inverting input terminal, an inverting input terminal and an output terminal, wherein the non-inverting input terminal is coupled to the first terminal of the capacitor C2, the inverting input terminal is coupled to the common node of resistors R3 and R4 to receive the threshold voltage VTH2, based on the voltage at the first terminal of the capacitor C2 and the threshold voltage VTH2, the comparator 214 provides the on-time control signal TON at the output terminal.

In normal working state, the diode D1 is at OFF state, the first switch M1 is turned ON when the feedback signal VFB is less than the reference voltage VREF, and is turned OFF when its on-time reaches a predetermined time threshold. When the switching frequency FS of the switching converter 300 approaches the audible range, the switching converter 300 enters the ultrasonic mode, the second setting signal SET2 is at the second state, the first switch M1 is turned ON even if the feedback signal VFB is still higher than the reference voltage VREF. The switching frequency FS of the switching converter 300 is limited to the minimum and so the audible noise is avoided. In an embodiment, the over-voltage condition of the output voltage VOUT over the first output limit is detected when the first voltage V1 is higher than the first voltage limit V_{LIM1}, the diode D1 is turned ON to conduct the first current, accordingly, the threshold voltage VTH2 is reduced and the on-time of the first switch M1 is reduced. However, if the load keeps decreasing, the on-time of the first switch M1 will be reduced to a minimum value, such as 50 ns, then the output voltage VOUT will keep increasing and the output voltage overshoot is still a little larger, so a second over-voltage condition of the output voltage VOUT over a second output limit may be detected, the second output limit is larger than the first output limit.

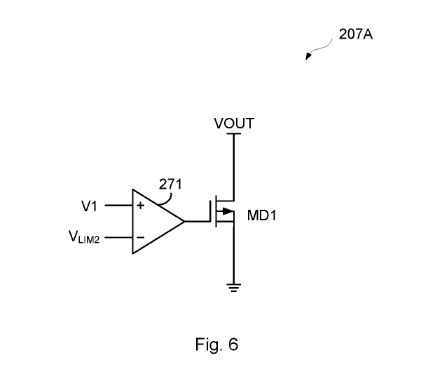

In one embodiment, if the second over-voltage condition of the output voltage VOUT over the second output limit is detected, the output voltage VOUT is reduced by turning ON a discharge switch. In a further embodiment, the control circuit in FIG. 5 further comprises a discharge circuit 207A. FIG. 6 illustrates a schematic circuitry diagram of a discharge circuit 207A in accordance with an embodiment of the present invention. The discharge circuit 207A has a comparator 271 and the discharge switch MD1. The comparator 271A is configured to detect the second over-voltage condition of the output voltage VOUT over the second output limit and provides a discharge signal. The comparator 271 has a non-inverting input terminal, an inverting input terminal and an output terminal, wherein the non-inverting input terminal is coupled to the common node of resistors R1 and R2 to receive the first voltage V1, the inverting input terminal is configured to receive a second voltage limit V_{LIM2}. The discharge switch MD1 has a drain terminal, a source terminal and a gate terminal, wherein the drain terminal is coupled to the output terminal of the switching circuit 205 to receive the output voltage VOUT, the source terminal is grounded, the gate terminal is coupled to the output terminal of the comparator 271. When the first voltage V1 is higher than the second voltage limit V_{LIM2}, the second over-voltage condition of the output voltage VOUT over the second output limit is detected, the discharge switch MD1 is turned ON by the discharge signal to create a discharge path for the output voltage VOUT until the output voltage VOUT falls below the second output limit.

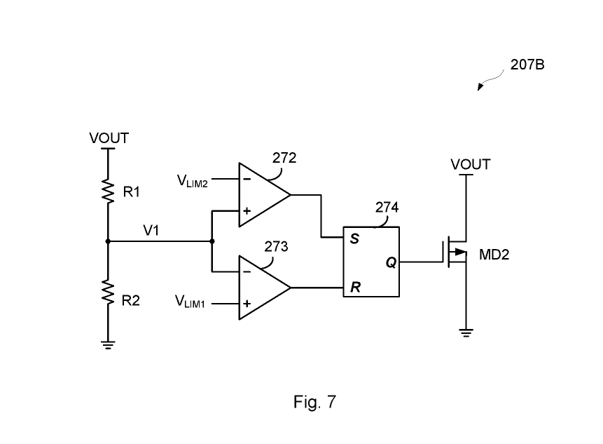

In another embodiment, a discharge circuit 207B can be added to the switching converter 100 and is configured to reduce the output voltage VOUT by creating a discharge path for the output voltage VOUT. FIG. 7 illustrates a schematic circuitry diagram of a discharge circuit 207B in accordance with another embodiment of the present invention. The discharge circuit 207B comprises resistors R1 and R2, comparators 272 and 273, a flip-flop 274 and a discharge switch MD2. The comparator 272 has a non-inverting input terminal, an inverting input terminal and an output terminal, wherein the non-inverting input terminal is configured to receive the first voltage limit V_{LIM1}, the inverting input terminal is coupled to the common mode of resistors R1 and R2 and is configured to receive the first voltage V1. The comparator 273 has a non-inverting input terminal, an inverting input terminal and an output terminal, wherein the non-inverting input terminal is configured to receive the first voltage V1, the inverting input terminal is configured to receive the second voltage limit V_{LIM2}. The flip-flop 274 has a setting terminal, a resetting terminal and an output terminal, wherein the setting terminal is coupled to the output terminal of the comparator 273, the resetting terminal is coupled to the output terminal of the comparator 274. The discharge switch MD2 has a drain terminal, a source terminal and a gate terminal, wherein the drain terminal is coupled to the output terminal of the switching circuit 205 to receive the output voltage VOUT, the source terminal is grounded, the gate terminal is coupled to the output terminal of the flip-flop 274.

When the first voltage V1 rises above the second voltage limit V_{LIM2}, the second over-voltage condition of the output voltage VOUT over the second output limit is detected, a discharge signal is provided to the discharge switch MD2, the discharge switch MD2 is turned ON to create a discharge path for the output voltage VOUT until the first voltage V1 falls below the first voltage limit V_{LIM1}. A person of ordinary skill in the art should know that in other embodiments, the discharge circuit may have different circuit configurations while having the same or similar function.

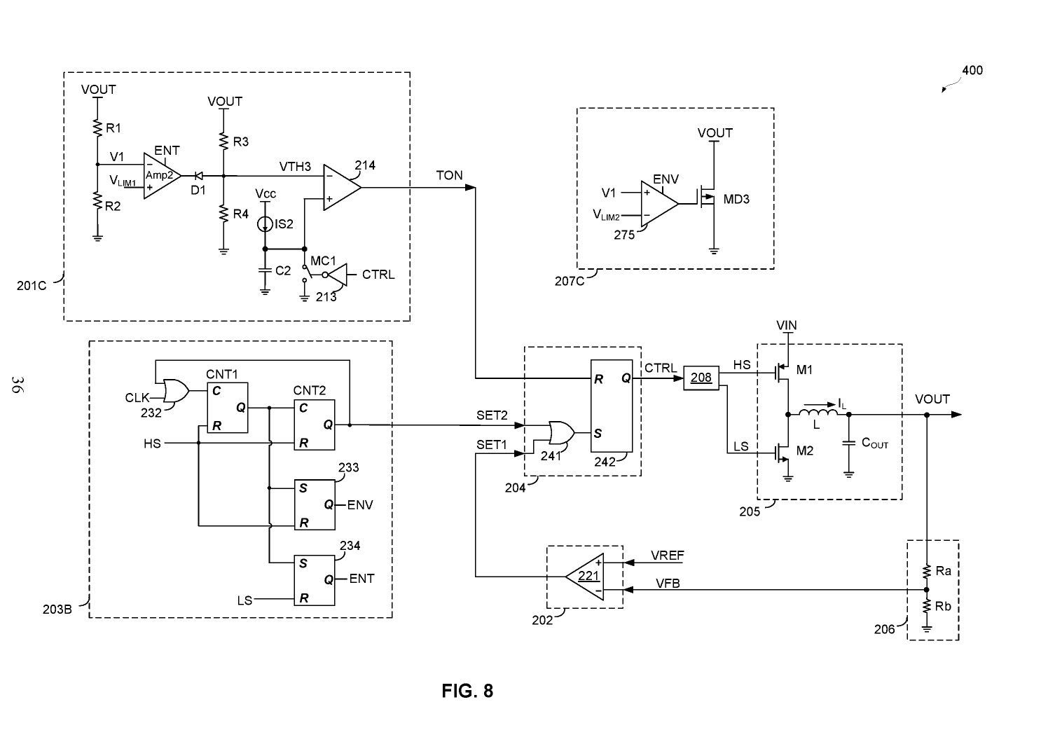

FIG. 8 illustrates a schematic circuitry diagram of a constant on-time switching converter 400 in accordance with yet another embodiment of the present invention. The switching converter 400 comprises a control circuit, a switching circuit 205, a feedback circuit 206 and a driving circuit 208. The control circuit comprises an on-time control circuit 201C, a comparing circuit 202, a mode determination circuit 203B, a logic circuit 204 and a discharge circuit 207C. The driving circuit 208 has an input terminal, a first output terminal and a second output terminal, wherein the input terminal is coupled to the output terminal of the logic circuit 204, the first output terminal and the second input terminal are configured to provide respectively the high side control signal HS for controlling the first switch M1 and the low side control signal LS for controlling the second switch M2.

As shown in FIG. 8, the mode determination circuit 203B comprises an OR gate 232, timers CNT1 and CNT2, flip-flops 233 and 234. The OR gate 232 has a first input terminal, a second input terminal and an output terminal, wherein the first input terminal is configured to receive a clock signal CLK, a second input terminal is configured to receive the second setting signal SET2. The time CNT1 has a clock terminal, an input terminal and an output terminal, wherein the clock terminal is coupled to the output terminal of the OR gate 232, the input terminal is configured to receive the high side control signal HS. The timer CNT2 has a clock terminal, an input terminal and an output terminal, wherein the clock terminal is coupled to the output terminal of the timer CNT1, the input terminal is configured to receive the high side control signal HS, the output terminal is configured to provide the second setting signal SET2. The timer CNT has a first reference time T1, the timer CNT2 has a second reference time T2, the sum of the first reference time T1 and the second reference time T2 equals with a time threshold, for example 32 μs. The timer CNT1 starts counting when the first switch M1 is turned OFF. When the first switch M1 is turned ON, both the timers CNT1 and CNT2 stop counting and are cleared. If the counting duration of the timer CNT1 exceeds the reference time T1, then at the end of time T1, if the first switch M1 is still at OFF state, and an output signal provided by the timer CNT1 transits from logic low state to logic high state. In this time, the timer CNT2 starts counting. If the counting duration of the timer CNT2 exceeds the reference time T2, then at the end of time T2, if the first switch M1 is still at OFF state, and the second setting signal SET2 provided by the timer CNT2 transits from logic low state to logic high state, and the first switch M1 is turned ON.

The flip-flop 233 has a setting terminal, a resetting terminal and an output terminal, wherein the resetting terminal is configured to receive the high side control signal HS, the setting terminal is coupled to the output terminal of the timer CNT1, the flip-flop 233 provides an enable signal ENV. The enable signal ENV is coupled to an enable terminal of the comparator 275 of the discharge circuit 207C and is used to enable the detecting of the second over-voltage condition of the output voltage VOUT over the second output limit. The flip-flop 234 has a setting terminal, a resetting terminal and an output terminal, wherein the resetting terminal is configured to receive the low side control signal LS, the setting terminal is coupled to the output terminal of the timer CNT1, the flip-flop 234 provides an enable signal ENT. The enable signal ENT is coupled to an enable terminal of the current operational amplifier Amp2 of the on-time control circuit 201C and is used to enable the detecting of the first over-voltage condition of the output voltage VOUT over the first output limit. The first output limit is smaller than the second output limit. Flip-flops 233 and 234 are configured together to enable the current operational amplifier Amp2 and the comparator 275 after the second reference time T1, the quiet current can be saved, while the functionality of the switching converter is not affected.

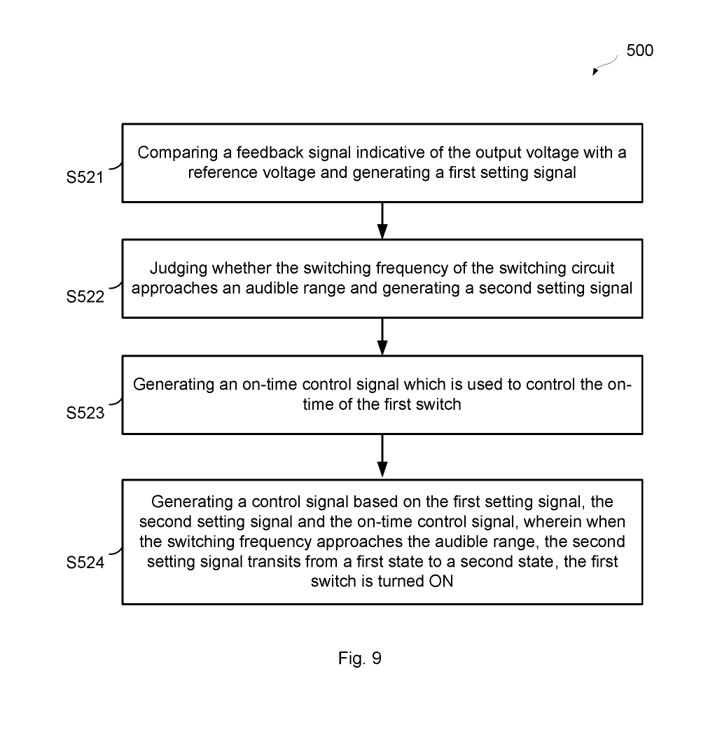

FIG. 9 illustrates a flow chart of a method 500 for controlling a switching converter in accordance with an embodiment of the present invention. The switching converter comprises a switching circuit having a first switch, the switching circuit is configured to convert an input voltage into an output voltage, the method 500 comprises steps S521˜S522.

At step S521, a feedback signal indicative of the output voltage of the switching circuit is compared with a reference voltage and a first setting signal is generated.

At step S522, whether the switching frequency of the switching converter approaches an audible range is judged and a second setting signal is generated. In one embodiment, if yes, the on-time of the first switch is reduced.

At step S523, an on-time control signal is generated and is used to control the on-time of the first switch.

At step S524, based on the first setting signal, the second setting signal and the on-time control signal, a control signal is generated and is used to control the first switch. The first switch is turned ON when the feedback signal is smaller than the reference voltage or the second setting signal transits from a first state to a second state, and the first switch is turned OFF when its on-time reaches a time threshold determined by the on-time control signal. In detail, when the switching frequency of the switching circuit approaches the audible range, the switching converter enters the ultrasonic mode, the second setting signal is at the second state, and the first switch is turned ON.

In an embodiment, in the ultrasonic mode, the on-time control signal is regulated to reduce the on-time of the first switch when a first over-voltage condition of the output voltage over a first output limit is detected. In a further embodiment, if a second over-voltage condition of the output voltage over a second output limit is detected, the output voltage is reduced by turning ON a discharge switch coupled between the output voltage and ground to create a discharge path, wherein the second output limit is higher than the first output limit.

In another embodiment, in the ultrasonic mode, when the second over-voltage condition of the output voltage over the second output limit is detected, a discharge signal is provided to a discharge switch coupled between the output voltage and ground, the discharge switch is turned ON to create a discharge path for the output voltage until the output voltage falls below the first output limit.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A controller used in a constant on-time switching converter, wherein the switching converter comprises a switching circuit having a first switch and configured to convert an input voltage into an output voltage, the controller comprises:
a comparing circuit having a first input terminal, a second input terminal and an output terminal, wherein the first input terminal is coupled to receive a feedback signal indicative of the output voltage of the switching circuit, the second input terminal is coupled to receive a reference voltage, wherein the comparing circuit compares the feedback signal and the reference voltage and generates a first setting signal at the output terminal;
a mode determination circuit configured to generate a second setting signal indicating whether the switching frequency of the switching circuit approaches an audible range;
an on-time control circuit configured to generate an on-time control signal which is used to control the on-time of the first switch;
a logic circuit coupled to the comparing circuit, the mode determination circuit and the on-time control circuit, wherein based on the first setting signal, the second setting signal and the on-time control signal, the logic circuit generates a control signal to control the first switch in the switching circuit; and wherein
when the switching frequency of the switching circuit approaches the audible range, the switching converter enters the ultrasonic mode, the second setting signal transits from a first state to a second state, and the first switch is turned ON.

2. The controller of claim 1, wherein the logic circuit comprises:
a first OR gate having a first input terminal, a second input terminal and an output terminal, wherein the first input terminal is coupled to the comparing circuit to receive the first setting signal, the second input terminal is coupled to the mode determination circuit to receive the second setting signal; and
a first flip-flop having a setting terminal, a resetting terminal and an output terminal, wherein the setting terminal is coupled to the output terminal of the first OR gate, the resetting terminal is coupled to the on-time control circuit to receive the on-time control signal, the first flip-flop provides the control signal at the output terminal.

3. The controller of claim 1, wherein in the ultrasonic mode, if a first over-voltage condition of the output voltage over a first output limit is detected, the on-time control signal is regulated to reduce the on-time of the first switch.

4. The controller of claim 3, wherein the on-time control circuit comprises:
a first current source having a first terminal and a second terminal, wherein the first terminal is coupled to a power supply, the second terminal is configured to provide a charge current;
a first capacitor having a first terminal and a second terminal, wherein the first terminal is coupled to the second terminal of the first current source, the second terminal is grounded;
a first inverting gate having an input terminal and an output terminal, wherein the input terminal is coupled to receive the control signal;
a first control switch having a first terminal, a second terminal and a control terminal, wherein the first terminal is coupled to the first terminal of the first capacitor, the second terminal is coupled to the second terminal of the first capacitor, the control terminal is coupled to the output terminal of the first inverting gate;
a first comparator having a non-inverting terminal, an inverting terminal and an output terminal, wherein the non-inverting terminal is coupled to the first terminal of the first capacitor, the inverting terminal is coupled to the receive a threshold voltage, the first comparator provides the on-time control signal at the output terminal; and wherein
when the first over-voltage condition of the output voltage over the first output limit is detected, the on-time of the first switch is reduced via increasing the charge current provided by the first current source or reducing the capacitance of the first capacitor.

5. The controller of claim 3, wherein the on-time control circuit comprises:
a first resistor having a first terminal coupled to the switching circuit to receive the output voltage and a second terminal;
a second resistor having a first terminal and a second terminal, wherein the first terminal is coupled to the second terminal of the first resistor and is configured to provide a first voltage, the second terminal is grounded;
a current amplifier having a non-inverting terminal, an inverting terminal and an output terminal, wherein the non-inverting terminal is coupled to receive a first voltage limit, the inverting terminal is configured to receive the first voltage, the current amplifier provides a first current at the output terminal;
a third resistor having a first terminal coupled to the switching circuit to receive the output voltage and a second terminal;
a fourth resistor having a first terminal and a second terminal, wherein the first terminal is coupled to the second terminal of the third resistor, the second terminal is grounded;
a diode having an anode and a cathode, wherein the anode is coupled to the second terminal of the third resistor, the cathode is coupled to the output terminal of the current amplifier;
a second current source having a first terminal and a second terminal, wherein the first terminal is coupled to a power supply, the second current source provides a charge current at the second terminal;
a second capacitor having a first terminal and a second terminal, wherein the first terminal is coupled to the second terminal of the second current source, the second terminal is grounded;
a second inverting gate having an input terminal and an output terminal, wherein the input terminal is coupled to receive the control signal;
a second control switch having a first terminal, a second terminal and a control terminal, wherein the first terminal is coupled to the first terminal of the second capacitor, the second terminal is grounded, the control terminal is coupled to the output terminal of the second inverting gate; and
a second comparator having a non-inverting terminal, an inverting terminal and an output terminal, wherein the non-inverting terminal is coupled to the first terminal of the second capacitor, the inverting terminal is coupled to the second terminal of the third resistor, the first comparator provides the on-time control signal at the output terminal.

6. The controller of claim 3, wherein in the ultrasonic mode, if a second over-voltage condition of the output voltage over a second output limit is detected, the output voltage is reduced by turning ON a discharge switch coupled between the output voltage and ground to create a discharge path, wherein the second output limit is higher than the first output limit.

7. The controller of claim 1, wherein in the ultrasonic mode, when the second over-voltage condition of the output voltage over the second output limit is detected, a discharge switch coupled between the output voltage and ground is turned ON to create a discharge path for the output voltage until the output voltage falls below the first output limit.

8. The controller of claim 1, wherein if the switching frequency is continuously smaller than the predetermined frequency in a predetermined time period, the switching frequency will be deemed as approaching the audible range, and the switching converter will enter into the ultrasonic mode.

9. A constant on-time switching converter, comprising:
a switching circuit having a first switch, wherein the switching circuit is configured to convert an input voltage into an output voltage;
a feedback circuit coupled to the output terminal of the switching circuit and configured to provide a feedback signal indicative of the output voltage;
a comparing circuit having a first input terminal, a second input terminal and an output terminal, wherein the first input terminal is coupled to receive the feedback signal, the second input terminal is coupled to receive a reference voltage, wherein the comparing circuit compares the feedback signal with the reference voltage and generates a first setting signal at the output terminal;
a mode determination circuit configured to generate a second setting signal indicating whether the switching frequency of the switching circuit approaches an audible range;
an on-time control circuit configured to generate an on-time control signal which is used to control the on-time of the first switch;
a logic circuit coupled to the comparing circuit, the mode determination circuit and the on-time control circuit, wherein based on the first setting signal, the second setting signal and the on-time control signal, the logic circuit generates a control signal to control the first switch in the switching circuit; and wherein
when the switching frequency of the switching circuit approaches the audible range, the switching converter enters the ultrasonic mode, the second setting signal transits from a first state to a second state, and the first switch is turned ON.

10. The switching converter of claim 11, wherein the logic circuit comprises:
a first OR gate having a first input terminal, a second input terminal and an output terminal, wherein the first input terminal is coupled to the comparing circuit to receive the first setting signal, the second input terminal is coupled to the mode determination circuit to receive the second setting signal; and
a first flip-flop having a setting terminal, a resetting terminal and an output terminal, wherein the setting terminal is coupled to the output terminal of the first OR gate, the resetting terminal is coupled to the on-time control circuit to receive the on-time control signal, the first flip-flop provides the control signal at the output terminal.

11. The switching converter of claim 9, wherein in the ultrasonic mode, if a first over-voltage condition of the output voltage over a first output limit is detected, the on-time control signal is regulated to reduce the on-time of the first switch.

12. The switching converter of claim 11, wherein the on-time control circuit comprises:
a first current source having a first terminal and a second terminal, wherein the first terminal is coupled to a power supply, the second terminal is configured to provide a charge current;
a first capacitor having a first terminal and a second terminal, wherein the first terminal is coupled to the second terminal of the first current source, the second terminal is grounded;
a first inverting gate having an input terminal and an output terminal, wherein the input terminal is coupled to receive the control signal;
a first control switch having a first terminal, a second terminal and a control terminal, wherein the first terminal is coupled to the first terminal of the first capacitor, the second terminal is coupled to the second terminal of the first capacitor, the control terminal is coupled to the output terminal of the first inverting gate;
a first comparator having a non-inverting terminal, an inverting terminal and an output terminal, wherein the non-inverting terminal is coupled to the first terminal of the first capacitor, the inverting terminal is coupled to the receive a threshold voltage, the first comparator provides the on-time control signal at the output terminal; and wherein
when the first over-voltage condition of the output voltage over the first output limit is detected, the on-time of the first switch is reduced via increasing the charge current provided by the first current source or reducing the capacitance of the first capacitor.

13. The switching converter of claim 11, wherein the on-time control circuit comprises:
a first resistor having a first terminal coupled to the switching circuit to receive the output voltage and a second terminal;
a second resistor having a first terminal and a second terminal, wherein the first terminal is coupled to the second terminal of the first resistor and is configured to provide a first voltage, the second terminal is grounded;
a current amplifier having a non-inverting terminal, an inverting terminal and an output terminal, wherein the non-inverting terminal is coupled to receive a first voltage limit, the inverting terminal is configured to receive the first voltage, the current amplifier provides a first current at the output terminal;
a third resistor having a first terminal coupled to the switching circuit to receive the output voltage and a second terminal;
a fourth resistor having a first terminal and a second terminal, wherein the first terminal is coupled to the second terminal of the third resistor, the second terminal is grounded;
a diode having an anode and a cathode, wherein the anode is coupled to the second terminal of the third resistor, the cathode is coupled to the output terminal of the current amplifier;
a second current source having a first terminal and a second terminal, wherein the first terminal is coupled to a power supply, the second current source provides a charge current at the second terminal;
a second capacitor having a first terminal and a second terminal, wherein the first terminal is coupled to the second terminal of the second current source, the second terminal is grounded;
a second inverting gate having an input terminal and an output terminal, wherein the input terminal is coupled to receive the control signal;
a second control switch having a first terminal, a second terminal and a control terminal, wherein the first terminal is coupled to the first terminal of the second capacitor, the second terminal is grounded, the control terminal is coupled to the output terminal of the second inverting gate; and
a second comparator having a non-inverting terminal, an inverting terminal and an output terminal, wherein the non-inverting terminal is coupled to the first terminal of the second capacitor, the inverting terminal is coupled to the second terminal of the third resistor, the first comparator provides the on-time control signal at the output terminal.

14. The switching converter of claim 11, wherein in the ultrasonic mode, if a second over-voltage condition of the output voltage over a second output limit is detected, the output voltage is reduced by turning ON a discharge switch which is coupled between the output voltage and ground to create a discharge path, wherein the second output limit is higher than the first output limit.

15. The switching converter of claim 14, wherein the mode determination circuit comprises:
a first timer having a first reference time, the first timer starts counting when the first switch is turned OFF and stops counting when the first switch is turned ON, when the counting duration of the first timer exceeds the first reference time, an output signal of the first timer transits from a first state to a second state;
a second timer having a second reference time, the second timer starts counting when the output signal of the first timer transits from the first state to the second state, when the counting duration of the second timer exceeds the second reference time, the second setting signal outputted by the second timer transits from a first state to a second state, the second timer stops counting when the first switch is turned ON and is cleared;
a second flip-flop having a setting terminal, a resetting terminal and an output terminal, wherein the setting terminal is coupled to the output terminal of the first timer, the resetting terminal is coupled to a low side control signal, the second flip-flop provides a first enable signal at the output terminal, the first enable signal is configured enable the detecting of the first over-voltage condition of the output voltage over the first output limit; and
a third flip-flop having a setting terminal, a resetting terminal and an output terminal, wherein the setting terminal is coupled to the output terminal of the first timer, the resetting terminal is coupled to a high side control signal, the third flip-flop provides a second enable signal at the output terminal, the second enable signal is used to enable the detecting of the second over-voltage condition of the output voltage over the second output limit.

16. The switching converter of claim 9, wherein in the ultrasonic mode, when the second over-voltage condition of the output voltage over the second output limit is detected, a discharge signal is provided to a discharge switch coupled between the output voltage and ground, the discharge switch is turned ON to create a discharge path for the output voltage until the output voltage falls below the first output limit.

17. A constant on-time control method used in a switching converter, wherein the switching converter comprises a switching circuit having a first switch and configured to convert an input voltage into an output voltage, the control method comprises:
comparing a feedback signal indicative of the output voltage with a reference voltage and generating a first setting signal;
judging whether the switching frequency of the switching circuit approaches an audible range and generating a second setting signal;
generating an on-time control signal which is used to control the on-time of the first switch; and
generating a control signal to control the first switch in the switching circuit based on the first setting signal, a second setting signal and the on-time control signal, wherein when the switching frequency of the switching circuit approaches the audible range, the switching converter enters the ultrasonic mode, the second setting signal transits from a first state to a second state, and the first switch is turned ON.

18. The control method of claim 17, wherein in the ultrasonic mode, the on-time control signal is regulated to reduce the on-time of the first switch when a first over-voltage condition of the output voltage over a first output limit is detected.

19. The control method of claim 18, wherein if a second over-voltage condition of the output voltage over a second output limit is detected, the output voltage is reduced by turning ON a discharge switch coupled between the output voltage and ground to create a discharge path, wherein the second output limit is higher than the first output limit.

20. The control method of claim 17, wherein in the ultrasonic mode, when the second over-voltage condition of the output voltage over the second output limit is detected, a discharge switch coupled between the output voltage and ground is turned ON to create a discharge path for the output voltage until the output voltage falls below the first output limit.
